(19) United States
(12) Patent Application Publication
(10) Pub. No.: US 2007/0229850 A1
(43) Pub. Date: Oct. 4, 2007

(54) SYSTEM AND METHOD FOR THREE-DIMENSIONAL IMAGE CAPTURE

(75) Inventor: Paul Herber, Dallas, TX (US)

Correspondence Address: JESSICA W. SMITH, 1529 PARKVIEW DRIVE, GARLAND, TX, 75043, US

(73) Assignee: BOXTERNAL LOGICS, LLC, DALLAS, TX (US)

(21) Appl. No.: 11/696,719

(22) Filed: Apr. 4, 2007

Related U.S. Application Data
(60) Provisional application No. 60/744,259, filed on Apr. 4, 2006.

(51) Int. Cl. G01B 11/24

(52) U.S. Cl. 356/604

(57) ABSTRACT

A three dimensional (3D) image capture system uses structured light technique. The 3D image capture system includes a first texture camera for capturing a textural image of a 3D object and a second geometry camera for capturing a geometric image of a 3D object while a structured light pattern is projected onto the 3D object. A pattern flash unit is used for projecting the structured light pattern onto the 3D object. The textural image is stored in a texture image file; and the geometric image is stored in a geometric image file. The geometric image file is processed to determine 3D coordinates and stored in a geometric image data file; and then the texture image file is processed to create texture data that is overlaid onto the 3D coordinates in the geometric image data file to produce a composite image.

### CROSS-REFERENCE TO RELATED APPLICATIONS

This application claims priority under 35 U.S.C. §120 to provisional application No. 60/744,259 filed Apr. 4, 2006, entitled “3D Image Capture System” which is incorporated herein by reference.

### BACKGROUND OF THE INVENTION

1. Field of the Invention

This invention relates to three dimensional image capturing, and more particularly, to an improved system and method for capturing three dimensional images using a structured light technique.

2. Description of the Related Art

Three Dimensional (3D) imaging systems are used to capture images of 3D objects and provide 3D geometry representations of the object, such as XYZ coordinates of the exterior of the object. The 3D geometry representations are then stored in an image file for processing to create data files. The resulting data files are then used in biometrics, Sub-Surface Laser Engraving, medical imaging, video and film production, holograms, video games and various other fields. One approach to capturing 3D geometric representations of an object is called structured light technique, as illustrated in FIG. 1. FIG. 1 shows an existing 3D image capture system 10 using a structured light technique. The 3D image capture system 10 includes a 3D object 14, a projector 12 and a camera 16. The 3D object 14 is placed at an approximate distance d₂ from the projector 12 and camera 16. The projector 12 and camera 16 are roughly in the same plane with respect to each other. The projector 12 projects an image onto the 3D object 14. The image is a structured light pattern. When the structured light pattern is projected onto the 3D object 14, it is distorted by the 3D object 14. The camera 16 captures an image of the 3D object 14 with the distortions in the structured light pattern. This image is then stored in an image file for processing. In some techniques, multiple structured light patterns are projected onto the 3D object 14 by the projector 12, and multiple images of the 3D object with the structured light patterns are captured by the camera 16 and stored in image files.

During processing of the image files, the distortions in the structured light pattern are analyzed and calculations performed to determine a spatial measurement of various points on the 3D object surface. This processing of the images uses well-known techniques in the industry, such as standard range-finding or triangulation methods. The known orientation parameters of the 3D image capture system 10 are used to calculate the distance of various portions on the 3D object based on the distorted pattern. The known orientation parameters include the distance d₁ between the projector 12 and camera 16 and the angle between the projector 12 and the camera 16. Once these range finding techniques are used to determine the XYZ coordinates of a plurality of points of the 3D object, then this 3D data representation of the 3D object 12 is stored in a data file. One example of a structured light technique showing processing of the images is disclosed in UK Patent Application No. 2410794 filed Feb. 5, 2004, which is incorporated herein by reference. Another example is provided in, “Composite Structured Light Pattern for Three-Dimensional Video,” by C. Guan, L. G. Hassebrook and D. L. Lau, Optics Express, Vol. 11, No. 5 dated Mar. 10, 2003, which is incorporated by reference herein.

The known 3D image capture systems, as shown in UK Patent Application No. 2410794, utilize standard projectors, such as LCD, CRT, LED or another digital or film projector for projecting the structured light pattern onto the 3D object. Typically, the maximum number of pixels that such projectors can display horizontally and vertically across an image is 1024×768. The projectors have a limited brightness as well. For example, high brightness projectors are typically only 1000-2500 ANSI lumens. The low lumen projectors require darkened environments for the structured light patterns to show on the 3D objects during image capture. Even with darkened environments, it is difficult to obtain contrast between the projected structured light pattern and the 3D object. This low contrast creates difficulties in the processing of the 3D images because the structured light pattern can not be discerned. Though some publicly available projector do have greater lumens, such as 6000 ANSI lumens, these projectors are extremely expensive and are prohibitive for lower cost devices.

The existing 3D image capture systems have other disadvantages as well. They are slow because they require projection of several frequencies of the structured light patterns and even multiple patterns. The projectors also require the 3D object to remain motionless during the process. The standard projectors are also expensive and tend to overheat with prolonged use.

Furthermore, typical 3D image capture systems use only one camera to capture the 3D geometry of an object. If multiple cameras are used, it is to capture different geographic areas of the 3D surface. So even with multiple cameras in existing 3D image capture systems, only one camera is taking images of a geographic area of the 3D surface for processing of its spatial coordinates.

Because of above, the known 3D image capture systems have many disadvantages, including low level of contrast between the structured light pattern and 3D object, slow image capture and lost image data.

Thus, there is a need for an improved 3D image capture system that is fast, easy to use and collects more image data with brighter and more contrasting structured light projection.

### BRIEF SUMMARY OF THE INVENTION

One embodiment of the present invention is a three dimensional (3D) image capture system using structured light technique. The 3D image capture system includes a first texture camera for capturing a texture image of a 3D object and a second geometry camera for capturing a geometric image of a 3D object while a structured light pattern is projected onto the 3D object. A pattern flash unit is used for projecting the structured light pattern onto the 3D object, wherein the pattern flash unit projects the structured light pattern using a short, intense burst of light. The textural image is stored in a texture image file; and the geometric image is stored in a geometric image file. The geometric image file is processed to create a 3D geometric representation of the 3D object in a geometric image data file, and the textural image file is processed for textural data. Then the textural data is overlaid onto the 3D geometric representation in the geometric image data file to produce a composite image.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates an existing 3D image capture system.

FIG. 2 illustrates a 3D imaging unit in one embodiment of the present invention.

FIG. 3 illustrates a 3D image capture system using the 3D imaging unit in one embodiment of the present invention.

FIG. 4 illustrates the steps in operation of the 3D image capture system in one embodiment of the present invention.

FIG. 5 illustrates in graphic form the relationship between a 3D object a texture camera, a geometry camera and pattern flash unit in one embodiment of the present invention.

FIG. 6 illustrates a view of a 3D object from a geometry camera viewpoint in one embodiment of the present invention.

FIG. 7 illustrates a 3D object from a texture camera and texture flash viewpoint in one embodiment of the invention.

FIG. 8 illustrates a composite of a texture camera and texture flash viewpoint and a geometry camera viewpoint in one embodiment of the invention.

FIG. 9 illustrates a 3D imaging unit in another embodiment of the invention.

FIG. 10 illustrates design of a pattern flash unit in one embodiment of the present invention.

FIG. 11 illustrates one embodiment of a structured light pattern of the present invention.

FIG. 12 illustrates a calibration device in one embodiment of the invention.

### DETAILED DESCRIPTION OF THE INVENTION

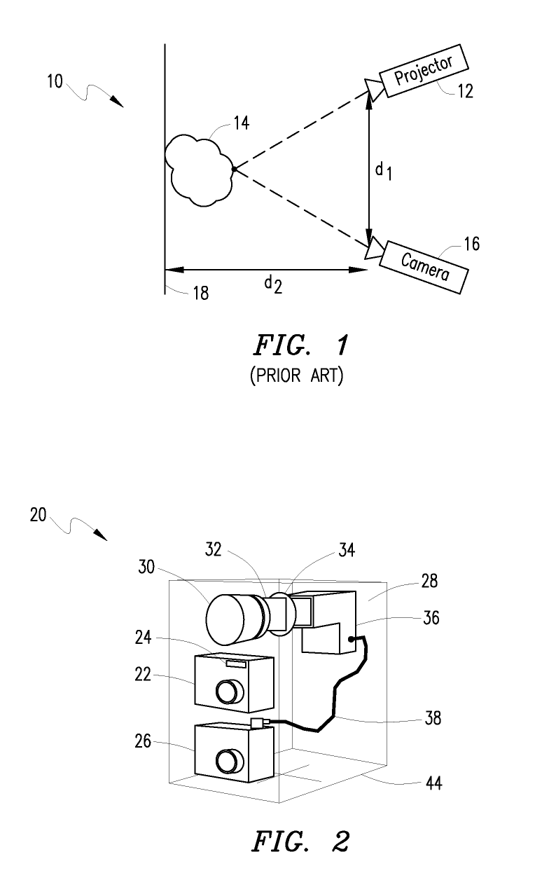

The present invention is best understood in relation to FIGS. 1 through 12 of the drawings, like numerals being used for like elements of the various drawings. The following description includes various specific embodiments of the invention but a person of skill in the art will appreciate that the present invention may be practiced without limitation to specific details described herein.

FIG. 2 illustrates one embodiment of the 3D image capture system of the present invention. A 3D imaging unit 20 includes a pattern flash unit 28 and two cameras: a texture camera 22 and a geometry camera 26. Preferably the pattern flash unit 28 and texture camera 22 and geometry camera 26 are positioned above one another in the center as shown in FIG. 2 but other angles between the cameras and pattern flash are possible depending on calibration. The distance d and angle between the pattern flash unit 28 and geometry camera 26 are calibrated as well.

The pattern flash unit 28 includes projection lens 30, a projection pattern slide 32, condenser lens 34 and the flash 36. The pattern slide 32 includes a structured light pattern to be projected onto a 3D object. The flash 36 is the light source. It can be any consumer or industrial camera flash or specialized camera flash tube. The flash 36 provides an intense burst of light in a short interval of time. This short, intense burst of light from the flash 36 is typically around a few milliseconds in duration but can be adjusted for shorter duration for high speed objects or longer duration for inanimate or distant objects depending on the calibration of the flash 36. This short, intense burst of light from the flash 36 is focused by the condenser lens 34. The condenser lens 34 focuses the light to more evenly illuminate the pattern slide 32 though depending on the application of the pattern flash unit 28, the condenser lens is not needed in all embodiments of the present invention.

The pattern slide 32 provides the desired structured light pattern, such as stripes or a grid or sinusoid. Different structured light patterns can be used for different subjects and situations. For example, for capture of hair on a person or animal, larger stripes in a series are a superior pattern. For capturing finer details, finer stripes in a series produce more resolution.

One of the problems encountered in processing of structured light images, is alleviating ambiguities in the connection of the stripes once the stripes are distorted by a 3D object. Especially with ridges and discontinuities, it is difficult to follow a single line from one side of the 3D object to the other side. A solution in one embodiment of the invention is to use alternating white strips with a different colored stripes in between, such as a pattern of stripes colored White, Red, White, Blue, White, Green, White, Purple, etc. Since the order of the colored stripe pattern is known, it is easier to identify the lines that should be connected when processing the image. An example of such a pattern slide is shown in FIG. 11. As seen in FIG. 11, the pattern slide in this embodiment 110, has alternating white stripes 114 with red stripes 112, green stripes 116 and blue strips 118 interlaced between the white stripes 112. Other patterns and configurations for the pattern slide 32 may be used as well.

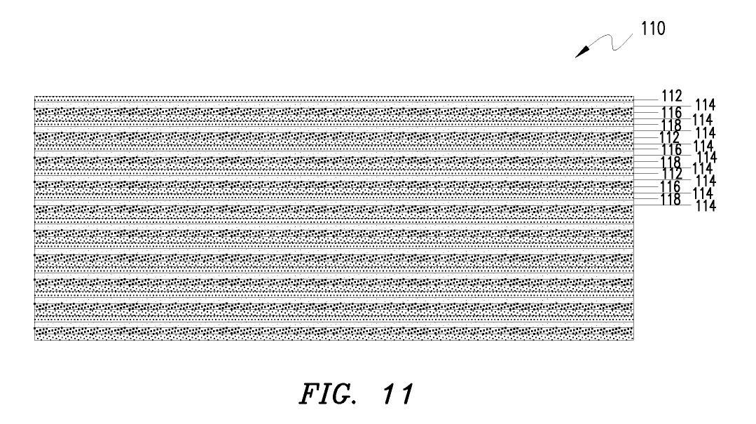

Referring again to FIG. 2, the projector lens 30 projects the structured light pattern of the pattern slide 32 onto the 3D object. For large 3D objects, the projector lens 30 is preferably a wide angle lens. For smaller 3D objects, other projector lens 30 may be more desirable. In addition, the distance between the lens and object may be adjusted. Optimizing the pattern flash unit 28 and its design are explained in more detail below with respect to FIG. 10.

As seen in FIG. 2, in this embodiment of the invention, the pattern flash unit 28 replaces the traditional standard projector 12 used in existing 3D image systems, to project a structured light pattern onto a 3D object. The pattern flash unit 28 is attached to the geometry camera 26 by a standard sync cable 38 or other sensor or triggering device. The sync cable 38 allows the pattern flash unit 28 to be automatically triggered by a signal of geometry camera 26 such that the geometry camera 26 and pattern flash unit 28 are synchronized with little or no delay such that the pattern flash unit 28 will project the structured light pattern while the geometry camera 26 captures an image. Unlike the standard projector 12, the pattern flash unit 28 does not require a cooling unit.

The texture camera 22, texture flash 24, geometry camera 26 and pattern flash unit 28 may be separate physical devices or are preferably mounted in a common enclosure 44. The common enclosure 44 allows the distance between the geometry camera 26 and pattern flash unit 28 and the angles of the geometry camera and pattern flash unit with respect to the 3D object to be easily measured and calibrated. These orientation parameters of the pattern flash unit 28 and geometry camera 26 with respect to the 3D object are necessary for certain techniques of processing the geometry images. Alternatively, one or more of the components may be built into a common physical device while other components are separated.

In operation, the texture camera 22 takes an image of a 3D object using the texture flash 24. The resulting texture image of the 3D object is stored in a texture image file. No structured light pattern is projected onto the 3D object during capture of the texture image file. As such, the texture camera is able to capture in more detail the texture of the 3D object, such as its colorization, that may be blurred or obscured by a structured light pattern. And since the flash for the texture camera 24 and the texture camera 22 are in close proximity and have similar angles with respect to the 3D object, there is little to no shadows in the texture image files from the texture flash 24.

Next, the geometry camera 26 in conjunction with the pattern flash unit 30 captures a geometric image of the 3D object with the structured light pattern projected onto the 3D object. The geometric image is stored in a geometric image file. The geometric image file is processed to determine a 3D geometry representation, such as XYZ coordinates, of the 3D object and stored in a geometric image data file. Then the texture image file is processed to create texture data which includes texture information, such as color and/or texture of a surface, and XY coordinates. The texture data is overlaid onto the 3D data in the geometric image data file to provide a composite image file with texture data and XYZ coordinates from the geometric data file. For example, the texture data has XY coordinates of the 3D object as well as texture and/or color information at each XY coordinate. This information is mapped to the XYZ coordinates in the geometric data file processed from the geometry camera 26. Thus, one composite file is created with XYZ coordinates and texture and/or color information of the 3D object.

In an alternative embodiment, the texture data processed from the texture image file can be stored to a texture data file. The texture data file would include the texture data and XY coordinates. The texture data file is overlaid onto the 3D data in the geometric image data file to provide a composite image file with texture data from the texture data file and XYZ coordinates from the geometric data file.

The two cameras thus capture an image of the same geographic area of a 3D object but provide different types of images and data to provide a more complete composite image. By using a flash for the projection of the structured light pattern, rather then a standard projector, the system is much faster, brighter, and less expensive. For example, in a comparison with a standard projector of 1700 Lumens, a flash is much brighter, at least more than 2 to 3 times as bright. The increased brightness of the flash creates more contrast between the structured light pattern and the 3D object. Due to the increased contrast, the geometric image will be easier to process. In addition, the texture camera has the ability to capture textural details that may have been in shadows or blurred in prior systems due to use of a projector. As explained above, the texture camera 22 and texture flash 24 are normal to the 3D object and in close proximity with respect to each other and so at similar angles with respect to the 3D object. This configuration creates less shadows in the texture images of the 3D object. Thus, more details of the texture without such shadows can be discerned during processing of the texture images.

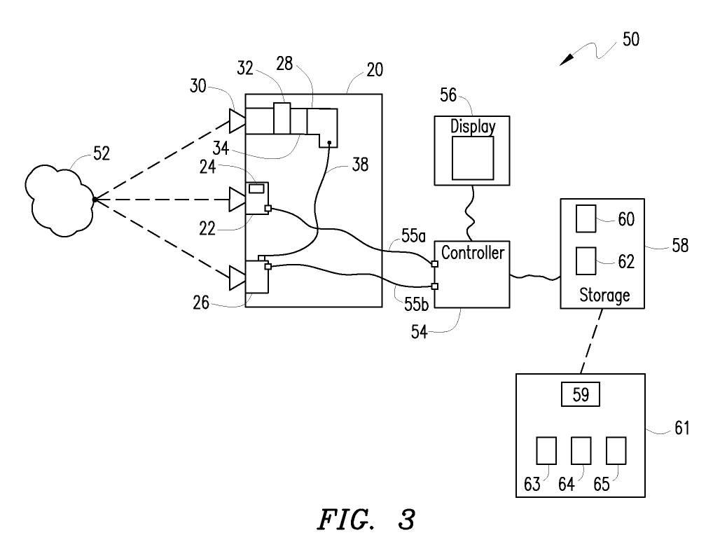

FIG. 3 illustrates a system 50 for 3D image capture using the 3D imaging unit 20. A 3D object 52 is positioned an approximate distance from the 3D imaging unit 20. The 3D object may be any animate or inanimate 3D object. The geometry camera 26 and flash unit 28 are shown as perpendicular to the 3D object 52 in FIG. 3, but a person of skill in the art would appreciate that the geometry camera 26 may be angled upwards toward the 3D object 52 and the flash unit 28 angled downwards toward the 3D object 52, or they may be angled to any appropriate position to capture the geometric image of the 3D object 52. In addition, the texture camera 22 and texture flash 24 may be moved or the 3D object 52 moved such that the texture camera 22 obtains an approximately normal position or is positioned approximately in front of the 3D object to be able to better capture the texture of the 3D object. Other positions and angles are possible for the texture camera 22 and texture flash 24 as well depending on the region of texture desired to be captured on the 3D object 52. Of course, as explained above, it is more advantageous for the texture camera 22 and texture flash 24 to have the same or similar angles with respect to the 3D object.

The 3D imaging unit is connected to a controller 54 through one or more cables 55. In a preferred embodiment, the controller 54 is a personal computer or other portable device, and the cables 55 are two USB cables from USB ports on the personal computer or other types of cables or methods of connection. One of the USB cables 55a connects the USB port on the personal computer to a USB port on the texture camera 22 in the 3D imaging unit 20 while the other USB cable 55b connects another USB port on the personal computer to the geometry camera 26 on the 3D imaging unit 20. Of course, a person of skill in the art would understand that the controller 54 may be connected to the 3D imaging unit 20 through other means, such as wireless devices, infrared or other means.

The controller 54 controls the operation of the 3D imaging unit 20. The controller 54 is connected to a display 56 and to a storage unit 58. The display 56 for example may be a personal computer screen and the storage unit a hard drive or flash drive or server or other memory device connected to or incorporated into the personal computer. The controller 54 is also attached to user devices, such as a mouse, keyboard or other user input device. Though shown as different physical devices, one or more of the components shown in FIG. 3 may be incorporated into one physical device. For example, the controller 54 may be incorporated into the 3D imaging unit 20 with a display 56, user interface 57 and storage unit 58. In addition, a centralized processing center 61 may be included as well. The texture image file 60 and geometric file 62 may be communicated to the centralized processing center 61 by email, FTP, or other means by the controller 54 or storage unit 58. The centralized processing center 61 includes one or more processing units 59 with operators that have expertise in processing the texture image file 60 and geometric image file 62 to create geometric image data files 63, texture data files 64, if used in a particular embodiment, and creating a resulting composite image file 65. The centralized processing center 61 may also perform other functions on a composite image file 65 such as create holograms, crystal images, or other services with the composite image file 65 before transferring to customers.

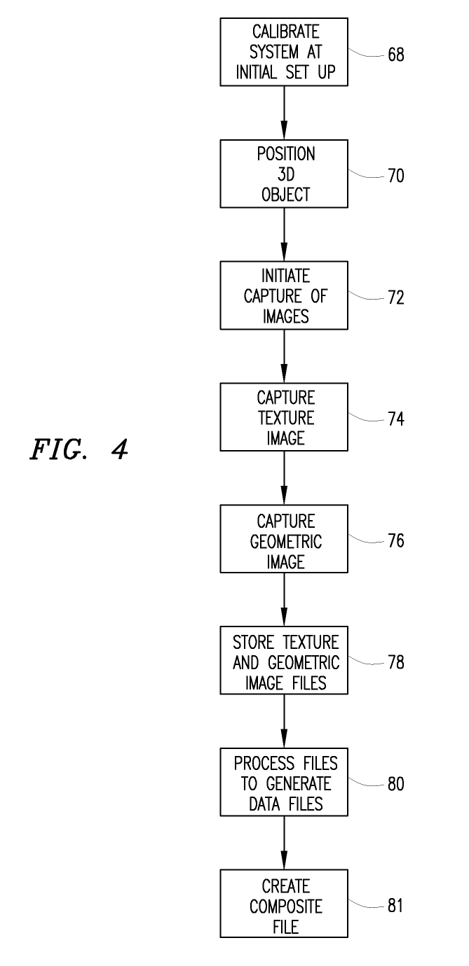

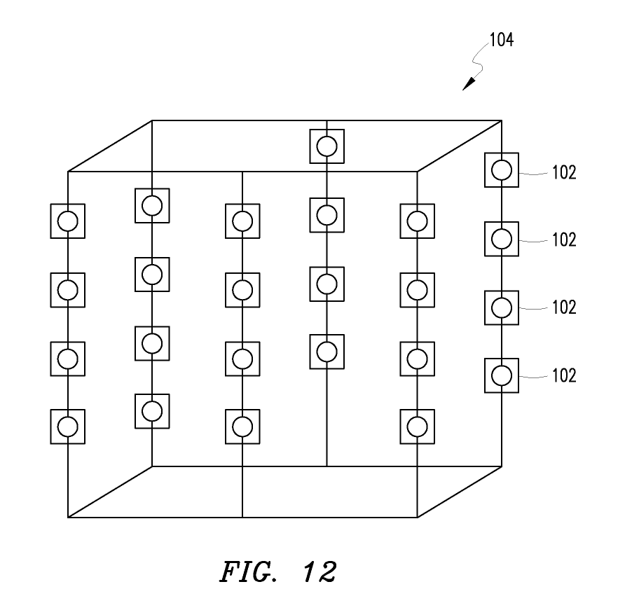

FIG. 4 illustrates the steps in operation of the 3D image capture system 50. In the first step 68, the 3D imaging unit 20 is calibrated. A calibration device 104, such as one shown in FIG. 12, is positioned as the 3D object 52 in FIG. 3. The calibration device includes markers 102 at predetermined distances. The structured light pattern is projected onto the calibration device 104 by the pattern flash unit 28, and the 3D imaging unit 20 captures geometric images with the geometry camera 26 for calibration purposes. The calculated calibration data is then used as indicators of ranges in processing of other 3D objects. The calibration process determines the angle between cameras 22 and 26 and the patter flash unit 28 so that the texture data files and geometric data files may be merged properly. The calibration step 68 is only performed during manufacturing or initial set up of the 3D imaging unit 20 or if some damage or other occurrence requires recalibration of the system.

In step 70, a 3D object is positioned in front of the 3D imaging unit 20 at an approximate distance. The distance can be adjusted through the above calibration and selection of the cameras and design of the pattern flash unit 28 as explained in more detail with respect to FIG. 10. When the 3D object is in position, the controller 54 initiates capture of the image in step 72. Preferably, the initiation of the 3D image is through a graphical user interface or keypad or other user device, using a single touch of a key or click of a mouse on a graphical interface. Once initiated, the texture camera 22 with texture flash 24 captures a texture image of the 3D object in step 74. The texture camera 22 takes the picture very quickly, such as a few milliseconds. Then automatically, the controller 52 triggers the geometry camera 26. The pattern flash unit 28 projects a structured light pattern onto the 3D object 52 while the geometry camera 26 captures the geometry image of the 3D object 52, as shown in step 76. Preferably, the geometry camera 26 triggers the pattern flash unit 28 through the sync cable 38. The pattern flash unit 28 and geometry camera also capture the image very quickly, such as a few milliseconds. The order of capture may be reversed. For example, the geometry camera 26 and the pattern flash unit 28 may first capture the geometry image and then the texture camera 22 and texture flash 24 may capture the texture image.

This whole process of capturing the two images is very fast, taking only milliseconds or a fraction of a second. Thus, the 3D imaging unit 20 is able to capture images of animals or children that may not remain still for long periods of time. In addition, as explained above, the use of the pattern flash unit 28 is at least 2-3 times as bright as a standard projector. This increased brightness provides for better detection of the structured light pattern in the geometry image, especially on darker 3D object surfaces. The contrast between the structured light pattern and the 3D object is enhanced enabling better structured light pattern detection in the geometric image file. Thus, geometry or XYZ coordinates on a 3D object that could not be discerned during processing in prior embodiments of a geometric image may now be detected.

In addition, because the texture camera 22 and texture flash 24 are at the same angle with respect to the 3D object 52, the texture camera 22 captures the texture image with minimal shadows. If the standard projector 12 in FIG. 1 with structured light pattern is used, shadows are created by the pattern or because of the different angle of the light from the projector 12 with respect to the camera 16. In this embodiment of the invention, the texture flash 24 creates fewer shadows with respect to the view of the texture camera 22 due to the common angle between the texture camera 22 and texture flash 24 with respect to the 3D object. Furthermore, the texture camera 22 is positioned at an orthogonal or normal angle to the 3D object so that it may better capture the color and texture of the 3D object 52 without shadows. Additional studio or flash lighting may also be used during capture of the texture image to further reduce shadows.

In FIG. 2 and FIG. 3, the pattern flash unit 28 is shown above the texture camera 22 and the geometry camera 26 is shown below the texture camera 22. The positions of the pattern flash unit 28 and the geometry camera 26 may be switched such that the pattern flash unit 28 is below the texture camera 22 and the geometry camera 26 is above the texture camera 22. Alternatively, the entire 3D imaging unit 20 can be positioned horizontal as shown from FIG. 2 or at other varying angles.

In the above process of FIG. 4, the texture image was captured with the texture camera 22 first and then the geometric image was captured second. This sequence is preferable for persons or animals. The first texture flash may cause the person or animal to blink before the second geometric image may be taken. A blink or closed eyes may not be detrimental to the geometric image. However, if the texture image captures closed eyes, then textural details will be lost, such as eye color. So for animals or persons, it is preferable to first capture the texture image and then the geometric image. For inanimate objects, it is feasible to capture the geometric image first with the geometry camera 26 and then the texture image with the texture camera 22, because this order does not have the same disadvantages as with persons and animals.

The texture image file 60 and the geometric image file 62 are transferred to the controller 54 or storage unit 58 in step 78. Preferably, the images are also shown on the display 56 to allow an operator to evaluate the images. The controller 54 may also perform an initial processing of the images to determine if the data is acceptable in the captured images and indicate status to an operator. Thus, an operator immediately knows whether additional images need to be captured of the 3D object 52. For example, the two images may be compared to determine whether the 3D object moved between the capture of the two images such that processing would be difficult. A red light or other indicator could then signal the operator that additional images need to be taken. If the images are satisfactory and acceptable for processing, a green light or other indicator could signal that to the operator. The operator then has quick feedback so images may be retaken with the subject if necessary.

The storage unit 58 may be a hard drive or flash drive, DVD, CD or other memory. The texture image file 60 and geometric image file 62 are transferred to the storage unit 58 and stored in the storage unit 58, as shown in step 78. The two images are then processed as shown in step 80 to create a single composite 3D image in step 81. This processing step 80 may be performed by the controller 54 concurrently or delayed. Alternatively, the stored texture image file 60 and geometric image file 62 may be transferred to an alternate or central processing unit for processing the images. For example the texture image file 60 and geometric image file 62 may be transferred by disk or email or other means to a centralized processing center 61 that is in a different geographic location. The centralized processing center 61 may include processing units 59 with operators that have expertise in processing the texture image file 60 and geometric image file 62 to create geometric image data files 63, texture data files 64, if used in certain embodiments, and the resulting composite image file 65. The centralized processing center 61 may also perform other functions on the composite image file 65 such as create holograms, crystal images, or other services with the composite image file 65 before transferring to customers.

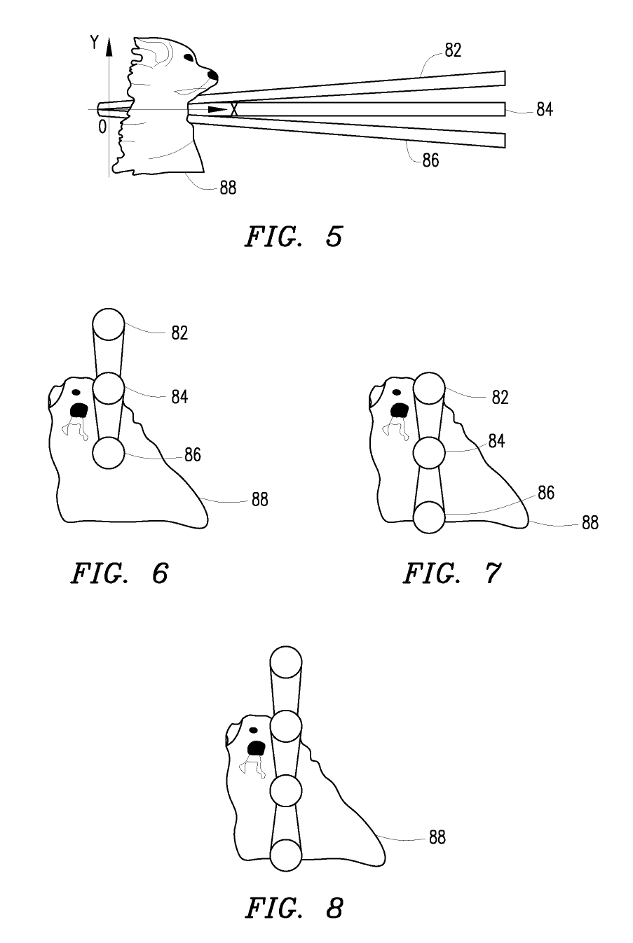

FIGS. 5 through 8 illustrate in graphic form the relationship between a 3D object 88, in this case a dog, and the texture camera 22, texture flash 24, geometry camera 26 and pattern flash unit 28. As seen in FIG. 5, in this specific embodiment of the present invention, the texture camera 22, pattern flash unit 28 and the geometry camera 26 are positioned on approximately a same XY plane but at different angles with respect to an origin O of the XY plane. As discussed above, the cameras may be at different angles or positioned along different planes depending on calibration of the system. The 3D object 88, in this embodiment a dog, is shown positioned in front of the cameras and pattern flash unit 28. The pattern flash unit 28 has a projection at a first projection angle 82 with respect to the 3D object 88. The geometry camera 26 has a geometry camera angle 86 that is a different angle than the projection angle 82 with respect to the 3D object 88. However, the texture camera 22 and texture flash 24 are directed at the 3D object 88 at an approximately the same texture camera/flash angle 84 and are positioned at a normal angle or directly in front of the 3D object 88. Though the angle 84 for the texture camera 22 and texture flash 24 may not be exactly the same, it is approximately the same and certainly at a much smaller angular difference than between the geometry camera angle 86 and pattern flash projection angle 82.

FIG. 6 is a view of the 3D object 88 from the geometry camera angle 86. FIG. 7 illustrates the 3D object from the texture camera/flash angle 84. As seen in FIG. 7, the angle from the texture camera 22 and texture flash 24 with respect to the 3D object is preferably orthogonal to the 3D object. A roughly orthogonal texture camera/flash angle 84 allows more of the features and texture of the 3D object to be captured. For example, as seen in FIG. 7, the top of the nose and the top of the head of the dog are visible from the texture camera/flash angle 84 but not from the geometry camera angle 86 in FIG. 6. In addition, as explained above, by placing the texture camera 22 and texture flash 24 at roughly the same angle, there is less loss of texture due to the shadows cast by having the flash originate from a different angle then the texture camera 22. FIG. 8 illustrates a combination of the texture camera/flash angle 84 and the geometry camera angle 86. This combination image shows the dramatic difference in the two views.

In the above descriptions, only one side or view or rotation of a 3D object was captured. It may be desirable in certain applications, to capture multiple sides, views or rotations of a 3D object. In an alternate embodiment of the invention, the 3D object may be rotated about an axis while the 3D imaging unit 20 captures a texture image and geometric image of each view or at each rotation of the 3D object. Alternatively, in another embodiment of the invention, multiple 3D imaging unit 20 may be positioned at different angles or sides of the 3D object. Each of the multiple 3D imaging units 20 may then capture a texture image and a geometric image of its respective view of the 3D object. Alternatively, the above embodiments may be combined, wherein multiple 3D imaging units 20 capture a texture image and a geometric image of a respective view of the 3D object while it is rotated or moved.

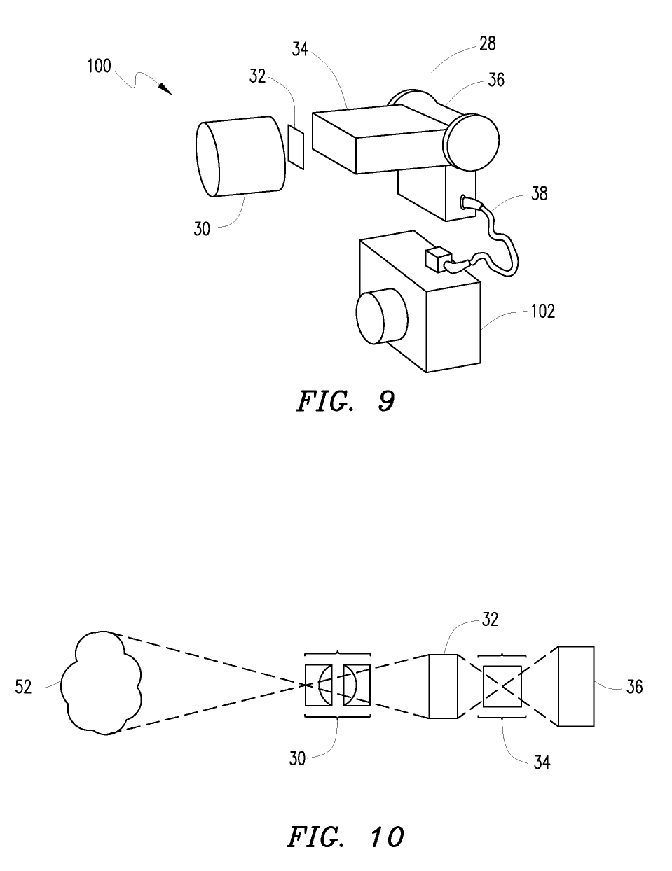

FIG. 9 illustrates an alternate embodiment 100 of the invention. In this alternate embodiment 100, a single camera 102 is used. The camera 102 is connected to a pattern flash unit 28 with a sync cable 38 so that the pattern flash unit 28 is synchronized with the camera 102. The pattern flash unit 28 includes a projection lens 30, projection pattern slide 32, condenser lens 34 and flash 36.

In this embodiment, the camera 102 is also a standard consumer or industrial camera or can be a specialized camera. The camera 102 is used to capture images for both the geometry and texture images. In one embodiment, the camera 102 can be set to continually take a series of images of the 3D object. The pattern flash unit 28 may not be synchronized with the camera 102 to flash with each capture of an image but only with one more images in the series.

In an alternate embodiment, the single camera 102 can capture two images of a 3D object. The camera 102 can capture a texture image with no flash or ambient light or studio lights or an alternate internal or external flash, such as alternate flash 104. The alternate flash 104 does not project a structured light pattern onto the 3D object. The camera 102 can subsequently capture a geometric image using pattern flash unit 28. Both the geometric image file and texture file are processed as described above.

The design of one embodiment of the pattern flash unit 28 is now described in more detail with respect to FIG. 10. The pattern flash unit 28 is a basic projector system. Condenser lens 34 is preferably a single lens but may be a double lens in some embodiments. The condenser lens 34 collects the light from the flash 36 and focus (condenses) the light to more evenly illuminate the pattern slide 32. The distance from the condenser lens 34 to the pattern slide 32 depends on the type of condenser lens 34. The condenser lens is behind the pattern slide 32 and the distance can be determined by the size of the pattern slide 32 and the focal point of the condenser lens as a person of skill in the art would appreciate. The condenser lens 34 must provide a shape of a cone of the projection light from the flash 36 to evenly illuminate the pattern slide 32. The choice of the lens 30 is determined by the filed of view and distance from the 3D object 52 for a particular embodiment of the invention.

The intensity and duration of the flash 36 can also be calibrated. The flash 36 provides a short, intense burst of light. Generally, the shorter the duration, the less intense the flash. For example, a typical commercial flash duration is from 1/800^{th} second to 1/20000^{th} of a second. For high speed subjects a shorter duration flash may be desired of 1/30,000 second. It then may be necessary to decrease the distance d from the subject to the pattern flash unit 28. Alternatively, for inanimate 3D objects at a distance, a more intense, longer duration flash may be desired at 1/800^{th} of a second. With flash units having variable-power control, more precise control of the flash duration is possible by selecting a fraction of a complete discharge at which the flash is quenched. So a balance between desired intensity of the flash 36 and duration of the flash 36 needs to be determined and calibrated for a particular 3D object and distance from the flash 36 to the 3D object. A person of skill in the art would understand that the flash 36 may have a range of settings for duration and intensity to obtain the desired goals.

In addition to the pattern flash unit 28, the settings of the cameras may also be adjusted to obtain the desired goals for a particular embodiment of the invention. The shutter speed of a camera regulates the duration of film exposure to the light coming through its lens. In addition, the f/stop regulates how much light is allowed to come through the lens. The ISO speed of a particular film, the shutter speed and f/stop need to be adjusted for optimum results for a particular embodiment of the invention. A person of skill in the art would understand how to adjust the ISO speed, f/stop and shutter speed of the geometry camera 26, texture camera 22 or camera 102 to obtain the desired goals for a particular embodiment of the invention.

The above described 3D image capture systems may be used in various applications and fields. For example, the 3D image capture system may be used to capture a composite image to create a 3D image representation for use with Sub-Surface Laser Engravings such as in a crystal. The 3D image capture system may be used in biometrics, such as face recognition and fingerprinting. The 3D image capture system in one or more embodiments of the present invention may also be used for medical imaging, such as plastic surgery to help illustrate reconstructive surgery or cosmetic surgery goals, video games, reverse engineering, 3D holograms, 3D lenticulars, biometrics, etc.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A three dimensional (3D) image capture system using structured light technique, comprising:
a texture camera for capturing a texture image of a 3D object; and
a geometry camera for capturing a geometric image of a 3D object while a structured light pattern is projected onto the 3D object.

2. The 3D image capture system of claim 1, further comprising:
a pattern flash unit for projecting the structured light pattern onto the 3D object, wherein the pattern flash unit projects the structured light pattern using a short, intense burst of light.

3. The 3D image capture system of claim 2, wherein the texture camera, pattern flash unit and the geometry camera are positioned on approximately a same plane but at different angles with respect to the 3D object.

4. The 3D image capture system of claim 3, further comprising:
a texture flash synchronized to provide a short intense burst of light while the first texture camera captures the texture image of a 3D object.

5. The 3D image capture system of claim 4, wherein the texture camera and the texture flash are positioned at an approximately normal angle with respect to the 3D object to avoid shadows.

6. The 3D image capture system of claim 5, wherein the pattern flash unit comprises:
a flash for providing a short intense burst of light;
a pattern slide with the structured light pattern; and
a projector lens for projecting the structured light pattern.

7. The 3D image capture system of claim 6, where the pattern flash unit further comprises:
a condenser lens positioned between the flash and the pattern slide for focusing the light from the flash to more evenly illuminate the pattern slide.

8. The 3D image capture system of claim 7, further comprising:
a controller connected to the geometry camera and texture camera and pattern flash unit for controlling capturing of the geometric image and texture image.

9. The 3D image capture system of claim 8, further comprising a storage unit for storing a texture image file with the texture image and a geometric image file with the geometric image.

10. A method for creating a three dimensional geometric representation of an object, comprising:
capturing a textural image of a 3D object with a first texture camera; and
capturing a geometric image of a 3D object with a second geometric camera while a structured light pattern is projected onto the 3D object.

11. The method of claim 10, further comprising:
projecting the structured light pattern onto the 3D object with a flash.

12. The method of claim 11, wherein the structured light pattern is projected onto the 3D object at a first angle and the geometric image is captured by the second geometric camera at a second angle.

13. The method of claim 12, wherein the step of capturing a textural image of a 3D object with a first texture camera further comprises:
projecting a flash onto the 3D object at a third angle; and
capturing the textural image of the 3D object with a first texture camera at approximately the same third angle.

14. The method of claim 11, further comprising:
storing the textural image in a texture image file; and
storing the geometric image in a geometric image file.

15. The method of claim 14, further comprising:
performing an initial processing of the texture image file and geometric image file to determine acceptability of data; and
providing an indication that image files are not acceptable to process and that additional images need to be captured.

16. The method of claim 14, further comprising:
processing the geometric image file to create a 3D geometric coordinates of the 3D object and storing the 3D geometric coordinates in a geometric image data file; and
processing the textural image file to create texture data and overlaying the texture data onto the 3D geometric coordinates in the geometric image data file to produce a composite image file.

17. The method of claim 16, further comprising:
calibrating at initial set up the geometric camera by projecting the structured light pattern onto a reference object with markers at a predetermined distance.

18. A three dimensional (3D) image capture system using structured light technique, comprising:
a pattern flash unit for projecting a structured light pattern onto a 3D object, wherein the pattern flash unit projects the structured light pattern using a short, intense burst of light.
at least one camera for capturing a geometric image of the 3D object while the structured light pattern is projected onto the 3D object.

19. The 3D image capture system of claim 18, wherein the at least one camera is connected to the pattern flash unit and triggers the pattern flash unit to project the structured light pattern while it captures a geometric image of the 3D object.

20. The 3D image capture system of claim 18, wherein the pattern flash unit comprises:
a flash for providing the short, intense burst of light;
a pattern slide with the structured light pattern; and
a projector lens for projecting the structured light pattern.
